(19) United States
(12) Patent Application Publication
(10) Pub. No.: US 2025/0250413 A1
(43) Pub. Date: Aug. 7, 2025

(54) RUBBER COMPOSITION AND PNEUMATIC TIRE

(71) Applicant: Toyo Tire Corporation, Itami-shi (JP)

(72) Inventor: Tatsuya Endo, Itami-shi (JP)

(73) Assignee: Toyo Tire Corporation, Itami-shi (JP)

(21) Appl. No.: 19/014,602

(22) Filed: Jan. 9, 2025

(30) Foreign Application Priority Data
Feb. 1, 2024 (JP) 2024-013867

(51) Int. Cl. C08K 3/34; B60C 1/00; C08K 3/06; C08K 3/22; C08K 5/09; C08K 5/548

(52) U.S. Cl. CPC C08K 3/34; B60C 1/00; C08K 3/06; C08K 3/22; C08K 5/09; C08K 5/548; C08K 2003/2296

(57) ABSTRACT

A rubber composition containing a diene-based rubber, silica, and an organic silane, wherein when an elastic modulus of a rubber at an interface between the silica and the diene-based rubber is defined as Ei and an elastic modulus of a matrix rubber is defined as Em, Ei/Em<1.5. It is preferred that the diene-based rubber is a modified styrene butadiene rubber. It is preferred that the organic silane is a compound having a terpene skeleton with a molecular weight of 200 to 1000.

### BACKGROUND OF THE INVENTION

### Field of the Invention

The present invention relates to a rubber composition and a pneumatic tire.

### Description of the Related Art

Pneumatic tires are designed to run under various conditions, and it is absolutely necessary to improve tire performance on, for example, wet roads (hereinafter also referred to as “WET performance”). Further, due to a recent request for resource saving, pneumatic tires are required to be fuel-efficient and are therefore also required to have improved low heat build-up contributing to fuel-efficiency.

Patent Document 1 mentioned below discloses a rubber composition for tires containing a diene-based rubber, silica, a sulfur-containing silane coupling agent, and a specific alkyltriethoxysilane, wherein 50 mass % or more of the diene-based rubber is a styrene-butadiene copolymer rubber, the sulfur-containing silane coupling agent has a mercapto group, a content of the silica is 5 to 150 parts by mass per 100 parts by mass of the diene-based rubber, a content of the sulfur-containing silane coupling agent is 3 to 15 mass % relative to the content of the silica, and a content of the alkyltriethoxysilane is 0.1 to 20 mass % relative to the content of the silica.

Patent Document 2 mentioned below discloses a rubber composition containing 100 parts by mass of a diene-based rubber, 20 to 150 parts by mass of silica, and an organic silane having a monosulfide bond (—C—S—C—) in an amount of 2 to 20 mass % relative to the mass of the silica.

### PRIOR ART DOCUMENT

### Patent Documents

Patent Document 1: JP-B2-4930661
Patent Document 2: JP-B2-6018001

### SUMMARY OF THE INVENTION

Both of Patent Documents 1 and 2 mentioned above disclose techniques to achieve both WET performance and fuel-efficiency of pneumatic tires. However, as a result of intensive studies, the present inventor has found that these techniques have room for improvement because WET performance and fuel-efficiency have a trade-off relationship.

In light of such circumstances, it is an object of the present invention to provide a rubber composition as a raw material of a vulcanized rubber for tires achieving a good balance between improved WET performance and improved fuel-efficiency, and a pneumatic tire including a vulcanized rubber of the rubber composition.

The above object can be achieved by the following configurations. Specifically, the present invention relates to a rubber composition (1) containing a diene-based rubber, silica, and an organic silane, wherein when an elastic modulus of a rubber at an interface between the silica and the diene-based rubber is defined as Ei and an elastic modulus of a matrix rubber is defined as Em, Ei/Em<1.5.

The rubber composition (1) is preferably a rubber composition (2) in which the diene-based rubber is a modified styrene-butadiene rubber.

The rubber composition (1) or (2) is preferably a rubber composition (3) in which the organic silane is a compound having a terpene skeleton with a molecular weight of 200 to 1000.

Any one of the rubber compositions (1) to (3) is preferably a rubber composition (4) in which the organic silane is a compound represented by the following general formula (1):

[Formula 1]

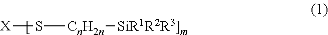

(wherein R¹, R², and R³ are each independently an alkyl group having 1 to 3 carbon atoms or an alkoxy group having 1 to 3 carbon atoms, at least one of R¹, R², and R³ is an alkoxy group, n is an integer of 2 to 4, X is a group having a terpene skeleton with a molecular weight of 200 to 1000, an intramolecular carbon-carbon double bond that X has is saturated or unsaturated, and X optionally contains a hetero element).

Any one of the rubber compositions (1) to (4) is preferably a rubber composition (5) in which the organic silane is a product of an ene-thiol reaction between a compound represented by the following general formula (2):

[Formula 2]

HS—CₙH₂ₙ—SiR¹R²R³ (2)

(wherein R¹, R², R³, and n are the same as those in the above formula (1)) and at least one compound selected from the group consisting of a compound represented by the following general formula (3a):

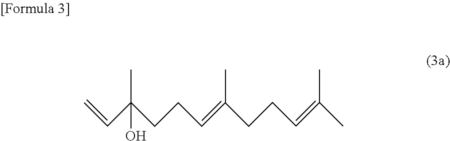

a compound represented by the following general formula (3b):

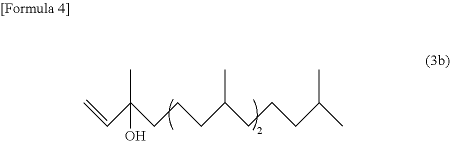

and a compound represented by the following general formula (3c):

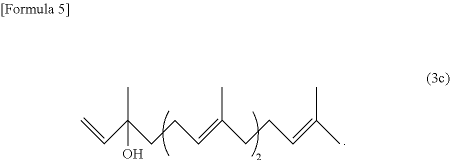

Any one of the rubber compositions (1) to (5) is preferably a rubber composition (6) in which the silica is contained in an amount of 30 to 150 parts by mass when an entire amount of the diene-based rubber is taken as 100 parts by mass, and the organic silane is contained in an amount of 3 to 30 mass % of the amount of the silica.

The present invention also relates to a pneumatic tire (7) including at least a vulcanized rubber of any one of the rubber compositions (1) to (6).

When silica is contained in a rubber composition as a reinforcing agent, particularly when a large amount of silica is contained, the filling effect of the silica tends to be insufficient due to deterioration in dispersibility of the silica in a rubber. Therefore, in order to improve dispersibility of silica in a rubber, various organic silanes (silane coupling agents) have been used. However, as a result of intensive studies, the present inventor has found that even when such an organic silane having heretofore been used is contained in a rubber together with silica, flexibilization of the interface between the rubber and the silica is insufficient, and therefore it is difficult to improve WET performance and fuel-efficiency of a vulcanized rubber to be finally obtained in a balanced way.

On the other hand, the rubber composition according to the present invention contains, in addition to a diene-based rubber and silica, an organic silane and is designed to satisfy Ei/Em<1.5, wherein Ei represents an elastic modulus of a rubber at an interface between the silica and the diene-based rubber and Em represents an elastic modulus of a matrix rubber. As a result, flexibility at the interface between the rubber and the silica is achieved so that the silica sufficiently exhibits its reinforcing effect, which improves WET performance and fuel-efficiency of a vulcanized rubber to be finally obtained in a balanced way.

In the present invention, particularly when a modified styrene-butadiene rubber is contained as a diene-based rubber and a compound having a terpene skeleton with a molecular weight of 200 to 1000 is contained as an organic silane, WET performance and fuel-efficiency of a vulcanized rubber to be finally obtained are improved in a particularly balanced way. The reason why such an effect is obtained is not clear, but the following reasons can be considered. The terpene skeleton with a molecular weight of 200 to 1000 of the organic silane has flexibility, and therefore when the terpene skeleton lies at the interface between the diene-based rubber and the silica, the interface between them can be flexibilized at a high level. In addition, the terpene skeleton with a molecular weight of 200 to 1000 can hydrophobize the surface of the silica at a high level, which makes it possible to improve dispersibility of the silica in the diene-based rubber. Further, when a modified styrene-butadiene rubber is used as a diene-based rubber, such an effect is further enhanced. As a result of these, WET performance and fuel-efficiency of a vulcanized rubber to be finally obtained are improved in a particularly balanced way due to excellent dispersibility of the silica in the rubber and a very flexible interface between them.

A vulcanized rubber of the rubber composition according to the present invention achieves a good balance between improved WET performance and improved fuel-efficiency. Therefore, a vulcanized rubber of the rubber composition according to the present invention is particularly useful for pneumatic tire treads.

### DETAILED DESCRIPTION OF THE PREFERRED EMBODIMENTS

A rubber composition according to the present invention contains a diene-based rubber, silica, and an organic silane.

Examples of the diene-based rubber contained in the rubber composition according to the present invention include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These butadiene-based rubbers may be used singly or in combination of two or more of them.

However, in the present invention, a modified styrene-butadiene rubber is preferably used as a diene-based rubber because WET performance and fuel-efficiency of a vulcanized rubber to be finally obtained are improved in a particularly balanced way. The “modified styrene-butadiene rubber” herein refers to a styrene-butadiene rubber having a functional group reactive with silica, and examples of the functional group reactive with silica include a hydroxyl group, an amino group, a carboxyl group, an alkoxy group, an alkoxysilyl group, and an epoxy group. Such a functional group may be introduced at the molecular end or into the molecular chain. From the viewpoint of improving WET performance and fuel-efficiency of a vulcanized rubber to be finally obtained in a particularly balanced way, the amount of the modified styrene-butadiene rubber contained is preferably 30 parts by mass or more, more preferably 50 parts by mass or more, particularly preferably 100 parts by mass when the entire amount of a rubber component is taken as 100 parts by mass.

Examples of the silica to be used include silicas usually used for rubber reinforcement, such as wet silica, dry silica, sol-gel silica, and surface-treated silica. Among these, wet silica is preferred. From the viewpoint of improving WET performance and fuel-efficiency of the vulcanized rubber, the amount of the silica contained is preferably 30 to 150 parts by mass, more preferably 50 to 120 parts by mass when the entire amount of the diene-based rubber contained in the rubber composition is taken as 100 parts by mass.

The rubber composition according to the present invention preferably contains, as an organic silane, a compound having a terpene skeleton with a molecular weight of 200 to 1000. If the molecular weight of the terpene skeleton of the organic silane is less than 200 or exceeds 1000, WET performance and fuel-efficiency tend to be insufficiently improved due to insufficient flexibilization of the interface between the diene-based rubber and the silica. In the present invention, the amount of the organic silane contained in the rubber composition is preferably 3 to 30 mass %, more preferably 3 to 15 mass % relative to the amount of the silica contained in the rubber composition.

In the present invention, the organic silane having a terpene skeleton with a molecular weight of 200 to 1000 is preferably a compound represented by the following general formula (1):

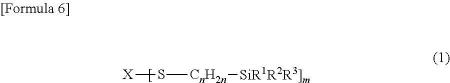

(wherein R¹, R², and R³ are each independently an alkyl group having 1 to 3 carbon atoms or an alkoxy group having 1 to 3 carbon atoms, at least one of R¹, R², and R³ is an alkoxy group, n is an integer of 2 to 4, X is a group having a terpene skeleton with a molecular weight of 200 to 1000, an intramolecular carbon-carbon double bond that X has is saturated or unsaturated, and X optionally contains a hetero element).

The organic silane used in the present invention is not limited as long as it is a compound having a terpene skeleton with a molecular weight of 200 to 1000, but a product of an ene-thiol reaction between a silicon-containing thiol compound and a compound having a terpene skeleton with a molecular weight of 200 to 1000 can more appropriately be used.

An example of the silicon-containing thiol compound is a silicon-containing thiol compound having a mercapto group and represented by the following general formula (2):

[Formula 7]

HS—CₙH₂ₙ—SiR¹R²R³ (2)

(wherein R¹, R², R³, and n are the same as those in the above formula (1)). A desired organic silane can be obtained through an ene-thiol reaction between a carbon-carbon double bond (C═C) that the compound having a terpene skeleton with a molecular weight of 200 to 1000 has and a mercapto group that the silicon-containing thiol compound having a mercapto group has. Specific examples of the compound represented by the general formula (2) include (3-mercaptopropyl)triethoxysilane, (3-mercaptopropyl)trimethoxysilane, (3-mercaptopropyl)methyldimethoxysilane, (3-mercaptopropyl)dimethylmethoxysilane, and mercaptoethyl triethoxysilane.

The compound having a terpene skeleton with a molecular weight of 200 to 1000 is not limited, and preferred examples thereof include a compound represented by the following general formula (3a)

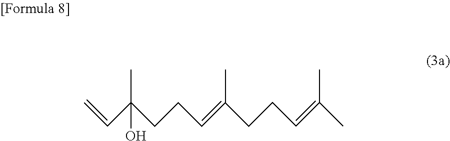

a compound represented by the following general formula (3b)

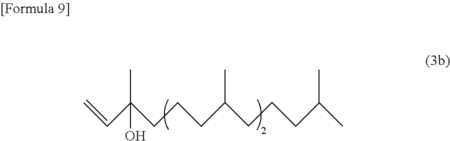

and a compound represented by the following general formula (3c)

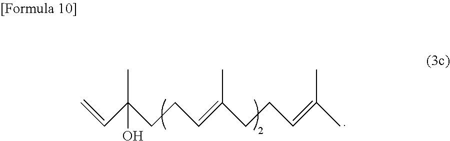

The compound represented by the general formula (3a), the compound represented by the general formula (3b), and the compound represented by the general formula (3c) may singly be subjected to an ene-thiol reaction with the silicon-containing thiol compound having a mercapto group to obtain an organic silane, or a mixture of at least two of these compounds or all of the three compounds may be subjected to an ene-thiol reaction with the silicon-containing thiol compound having a mercapto group to obtain an organic silane.

The ene-thiol reaction is preferably performed using a radical generator as a reaction catalyst. A radical reaction may be performed by ultraviolet (UV) irradiation. Examples of the radical generator include an azo compound and an organic peroxide. Such radical generators include one that generates radicals by heat and one that generates radicals by light irradiation. Examples of the azo compound include azobisisobutyronitrile (AIBN) and 1,1′-azobis(cyclohexanecarbonitrile) (ABCN). Examples of the organic peroxide include di-tert-butylperoxide, tert-butylhydroperoxide, benzoyl peroxide, and methyl ethyl ketone peroxide.

The ene-thiol reaction can be performed by, for example, mixing the compound represented by the general formula (2), the compound having a terpene skeleton with a molecular weight of 200 to 1000, and a radical generator together with an organic solvent such as toluene and maintaining the mixture under conditions for generating radicals. The reaction temperature is preferably 50 to 120° C.

The organic silane having a terpene skeleton with a molecular weight of 200 to 1000 has a monosulfide bond (—C—S—C—) in its molecule, and its affinity for the diene-based rubber is improved by reacting with the diene-based rubber due to thermal cleavage of such a moiety or by at least having a monosulfide bond. Further, when the organic silane having a terpene skeleton with a molecular weight of 200 to 1000 lies at the interface between the diene-based rubber and the silica, the interface between them can be flexibilized at a high level because the terpene skeleton with a molecular weight of 200 to 1000 has flexibility. Therefore, WET performance and fuel-efficiency of a vulcanized rubber of the rubber composition according to the present invention are improved in a balanced way due to excellent dispersibility of the silica in the rubber and a very flexible interface between them.

The organic silane having a terpene skeleton with a molecular weight of 200 to 1000 used in the present invention is preferably a compound represented by the above general formula (1), particularly preferably a compound represented by the following general formula (4a):

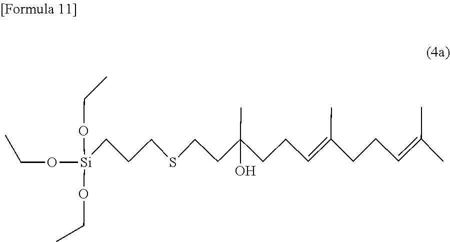

a compound represented by the following general formula (4b)

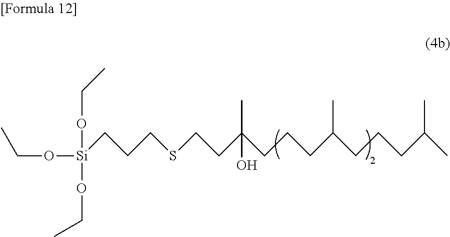

or a compound represented by the following general formula (4c)

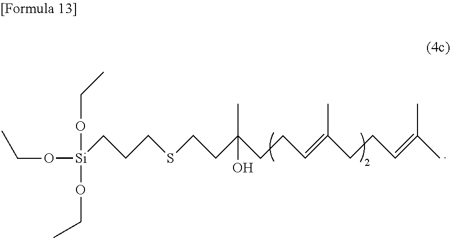

The rubber composition according to the present invention is a rubber composition containing the above-described diene-based rubber, silica, and organic silane, wherein when an elastic modulus of a rubber at an interface between the silica and the diene-based rubber is defined as Ei and an elastic modulus of a matrix rubber is defined as Em, Ei/Em<1.5. In the rubber composition according to the present invention, the silica and the organic silane are reacted and the organic silane and the diene-based rubber are reacted so that a rubber (bound rubber) is formed at the interface between the silica and the diene-based rubber. When Ei/Em<1.5, the rubber (bound rubber) at the interface between the silica and the diene-based rubber has flexibility, which improves WET performance and fuel-efficiency of a vulcanized rubber to be finally obtained in a balanced way.

In the present invention, the elastic modulus Ei of the rubber (bound rubber) at the interface between the silica and the diene-based rubber in the rubber composition can be determined by, for example, force curve measurement with an atomic force microscope. The atomic force microscope (AFM) is one of scanning probe microscopes and detects a force acting between the atom of a sample and the atom of a probe. The probe is attached to the tip of a cantilever (cantilever spring), and a force acting on the cantilever (the amount of deflection) is measured while the distance between the sample and the probe is changed to obtain a force curve by plotting the relationship between them. By analyzing the force curve, the elastic modulus (hardness) of a sample surface can be determined. Determining the elastic modulus of a sample surface by force curve measurement in such a manner is publicly known per se, and force curve measurement can be performed using such a publicly known method.

Force curves are obtained by scanning a sample surface at various positions within a predetermined range, and a histogram is formed from elastic moduli determined from the respective force curves. Peak separation is performed on this histogram so that the peak is divided into three components, that is, a silica component, a diene-based rubber component, and a component having an elastic modulus higher than that of a matrix rubber component and lower than that of the silica component (a rubber (bound rubber) component at the interface between the silica and the diene-based rubber). This makes it possible to determine, as the amount of the bound rubber, the volume fraction of the bound rubber in the rubber composition.

It should be noted that when the amount of silica contained as a filler is known, the volume fraction of the bound rubber in the rubber composition may be determined by calculating the volume fraction of the silica from the amount of the silica contained and, before the peak separation of the histogram, previously subtracting the volume fraction of the silica calculated from the amount of the silica contained and then separating the residue into a matrix rubber component and a bound rubber component.

For details, a method described in “Structural, physical property analysis approach in nanoregion at filler/polymer interface using atomic force microscope” (written by Ken Nakajima and other two authors, published by the Adhesion Society of Japan, Adhesion Technology, Japan, Vol. 35, No. 3, pp. 13-17, 2015) can be used as a reference. Specifically, the volume fraction of a high elastic modulus component corresponding to silica is previously subtracted from the histogram of elastic modulus. Then, the low elastic modulus-side peak of the histogram is fitted to a normal distribution by a log-normal function. The area surrounded by the fitting curve is defined as a matrix rubber component. A component out of the fitting curve in the histogram can be regarded as a bound rubber component to determine the volume fraction of the bound rubber component. Further, the elastic modulus of the bound rubber component (the elastic modulus Ei of a rubber at the interface between the silica and the diene-based rubber) can be determined from the average of the elastic modulus histogram of the bound rubber component.

In the present invention, the elastic modulus Em of the matrix rubber in the rubber composition can be calculated as the weighted average of elastic moduli determined from the force curves obtained using the atomic force microscope (AFM) from which the filler component and the bound rubber component have been removed.

The rubber composition according to the present invention may contain, in addition to the diene-based rubber, the silica, and the organic silane, a silane coupling agent other than the organic silane, carbon black, a vulcanizing agent, a vulcanization accelerator, an antiaging agent, stearic acid, a softener such as wax or oil, a processing aid, and others.

As the silane coupling agent other than the organic silane that is a compound having a terpene skeleton with a molecular weight of 200 to 1000, a sulfur-containing silane coupling agent is suitably used. Examples of the sulfur-containing silane coupling agent include: sulfidesilanes such as bis(3-triethoxysilylpropyl)tetrasulfide (e.g., “Si69” manufactured by Evonik Japan Co., Ltd.), bis(3-triethoxysilylpropyl)disulfide (e.g., “Si75” manufactured by Evonik Japan Co., Ltd.), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

Examples of the carbon black that can be used include carbon blacks usually used in the rubber industry, such as SAF, ISAF, HAF, FEF, and GPF; and conductive carbon blacks such as acetylene black and ketjen black.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the vulcanizing agent in the rubber composition according to the present invention is preferably 0.5 to 3.5 parts by mass when the entire amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition according to the present invention is obtained by kneading, in addition to the diene-based rubber, the silica, and the organic silane, a silane coupling agent other than the organic silane, carbon black, a vulcanizing agent, a vulcanization accelerator, an antiaging agent, stearic acid, a softener such as wax or oil, a processing aid, and others with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

A vulcanized rubber of the rubber composition according to the present invention achieves a good balance between improved WET performance and improved fuel-efficiency. Therefore, a vulcanized rubber of the rubber composition according to the present invention is particularly useful for pneumatic tire treads.

### EXAMPLES

Hereinbelow, the present invention will more specifically be described with reference to examples.

### [Measurement Method of Elastic Modulus Ei of Rubber at Interface Between Silica and Diene-Based Rubber in Rubber Composition and Elastic Modulus Em of Matrix Rubber]

As an atomic force microscope, “Dimension Icon” manufactured by Bruker was used, and as a cantilever, “OMCL-AC240TS-R3” manufactured by OLYMPUS CORPORATION was used. Force curves were measured at 128×128 points in an area of 3 μm×3 μm with the use of such an atomic force microscope, and elastic moduli and adhesion forces were determined from the respective force curves to form distribution curves. The filler in the rubber composition was low in adhesion force, and therefore elastic moduli determined from the force curves showing low adhesion force and corresponding to the amount of the filler contained (in this example, 18 vol %) out of the force curves measured at 128×128 points were defined as the elastic moduli of the filler. Then, the amount of a bound rubber was determined from the amount of gel that remained after the unvulcanized rubber was subjected to extraction with toluene, and on the basis of this value, the weighted average of elastic moduli determined from the force curves showing low adhesion force and corresponding to the amount of the bound rubber out of the force curves from which the filler component had been subtracted was determined and defined as an interface elastic modulus (Ei). Finally, the weighted average of elastic moduli determined from the force curves measured at 128×128 points from which the filler component and the bound rubber component had been removed was determined and defined as the elastic modulus (Em) of a matrix rubber.

### [Preparation of Rubber Composition and Vulcanized Rubber]

According to each of formulations (parts by mass) shown in Table 1 and Table 2, a diene-based rubber was subjected to mastication for 30 seconds with the use of a labo mixer (300 cc) manufactured by DAIHAN CO., LTD., silica, an organic silane or a silane coupling agent, zinc oxide, and stearic acid were then added thereto, and the resultant was kneaded for 240 seconds. Then, the thus obtained rubber composition was discharged. Then, the discharged rubber composition was charged into the labo mixer and kneaded for 180 seconds and then discharged. Further, the discharged rubber composition, sulfur, and a vulcanization accelerator were charged into the labo mixer and kneaded for 60 seconds. Then, the thus obtained unvulcanized rubber composition was discharged. The unvulcanized rubber composition was subjected to sheeting using two rolls to have a thickness of 2 mm and was then subjected to vulcanizing press at 160° C. for 20 minutes to obtain a vulcanized rubber sample. The compounding agents shown in Table 1 and Table 2 are as follows.

### (Diene-Based Rubber)

SBR (1): “SBR1502” manufactured by ENEOS Materials Corporation
SBR (2): “Tufdene 2000R” manufactured by Asahi Kasei Corp.
SBR (3): “SL563” manufactured by ENEOS Materials Corporation
SBR (4): “HPR350” manufactured by ENEOS Materials Corporation, amine-terminated modified S-SBR

### (Silica)

“Nipsil AQ” manufactured by Tosoh Corporation

### (Silane Coupling Agent (Sulfur-Containing Silane Coupling Agent))

“Si75” manufactured by Evonik Japan Co., Ltd.

### (Organic Silane)

Organic silane (1) (compound having terpene skeleton with molecular weight of 200 to 1000): one produced by the following synthetic method 1

### (Synthetic Method 1)

First, 46.6 g of nerolidol (manufactured by Tokyo Chemical Industry Co., Ltd.) represented by the above general formula (3a), 50.0 g of (3-mercaptopropyl)triethoxysilane (manufactured by Tokyo Chemical Industry Co., Ltd.), 3.4 g of 2,2′-azobis(isobutylnitrile) (manufactured by Wako Pure Chemical Industries, Ltd.), and 100 mL of toluene were mixed in an eggplant flask, and the mixture was subjected to bubbling with nitrogen gas for 30 minutes and then subjected to reaction at 70° C. for 24 hours. Then, the reaction solution was concentrated to obtain 94.8 g of a pale yellow liquid (yield: 98 mass %). As a result of NMR measurement, the product was confirmed to be nerolidol silane represented by the above general formula (4a). The product was defined as an “organic silane (1)”.
Organic silane (2) (compound having terpene skeleton with molecular weight of 200 to 1000): one produced by the following synthetic method 2

### (Synthetic Method 2)

First, 60.9 g of geranyl-linalool (manufactured by Tokyo Chemical Industry Co., Ltd.) represented by the above general formula (3b), 50.0 g of (3-mercaptopropyl)triethoxysilane (manufactured by Tokyo Chemical Industry Co., Ltd.), 3.4 g of 2,2′-azobis(isobutylnitrile) (manufactured by Wako Pure Chemical Industries, Ltd.), and 100 mL of toluene were mixed in an eggplant flask, and the mixture was subjected to bubbling with nitrogen gas for 30 minutes and then subjected to reaction at 70° C. for 24 hours. Then, the reaction solution was concentrated to obtain 109.2 g of a pale yellow liquid (yield: 98 mass %). As a result of NMR measurement, the product was confirmed to be geranyl-linalool silane represented by the above general formula (4b). The product was defined as an “organic silane (2)”.
Organic silane (3) (compound having terpene skeleton with molecular weight of 200 to 1000): one produced by the following synthetic method 3

### (Synthetic Method 3)

First, 62.2 g of isophytol (manufactured by Tokyo Chemical Industry Co., Ltd.) represented by the above general formula (3c), 50.0 g of (3-mercaptopropyl)triethoxysilane (manufactured by Tokyo Chemical Industry Co., Ltd.), 3.4 g of 2,2′-azobis(isobutylnitrile) (manufactured by Wako Pure Chemical Industries, Ltd.), and 100 mL of toluene were mixed in an eggplant flask, and the mixture was subjected to bubbling with nitrogen gas for 30 minutes and then subjected to reaction at 70° C. for 24 hours. Then, the reaction solution was concentrated to obtain 111.0 g of a pale yellow liquid (yield: 99 mass %). As a result of NMR measurement, the product was confirmed to be isophytol silane represented by the above general formula (4c). The product was defined as an “organic silane (3)”.

### (Other Compounding Agents)

Zinc white (zinc oxide): “Zinc Oxide Grade 3” manufactured by MITSUI MINING & SMELTING CO., LTD.
Stearic acid: “LUNAC S-20” manufactured by Kao Corporation
Sulfur: “Powder Sulfur” manufactured by Tsurumi Chemical Industry Co., ltd.
Vulcanization accelerator (1): “SOXINOL CZ” manufactured by SUMITOMO CHEMICAL COMPANY, LIMITED
Vulcanization accelerator (2): “NOCCELER D” manufactured by OUCHI SHINKO CHEMICAL INDUSTRIAL CO., LTD.

The obtained vulcanized rubber sample was evaluated according to the following criteria.

### [Wet Performance (Wet Grip Performance)]

A loss coefficient tan δ was measured at a frequency of 10 Hz, a static strain of 10%, a dynamic strain of 1%, and a temperature of 0° C. using a viscoelasticity tester manufactured by Ueshima Seisakusho Co., Ltd. In Table 1, WET performance of Comparative Example 2, Comparative Example 4, Comparative Example 6, and Example 1 was expressed as index numbers determined when the loss coefficients of Comparative Example 1, Comparative Example 3, Comparative Example 5, and Comparative Example 7 were taken as 100, respectively. In Table 2, WET performance of Examples 2 and 3 was expressed as index numbers determined when the loss coefficient of Comparative Example 8 was taken as 100. In all of these cases, a larger index number indicates that tan δ is larger, that is, a tire excellent in wet grip performance can be obtained.

### [Fuel-Efficiency (Low Heat Build-Up)]

A loss coefficient tan δ was measured at a frequency of 10 Hz, a static strain of 10%, a dynamic strain of 1%, and a temperature of 60° C. using a viscoelasticity tester manufactured by Ueshima Seisakusho Co., Ltd. In Table 1, low heat build-up of Comparative Example 2, Comparative Example 4, Comparative Example 6, and Example 1 was expressed as index numbers determined when the loss coefficients of Comparative Example 1, Comparative Example 3, Comparative Example 5, and Comparative Example 7 were taken as 100, respectively. In Table 2, low heat build-up of Examples 2 and 3 was expressed as index numbers determined when the loss coefficient of Comparative Example 8 was taken as 100. In all of these cases, a smaller index number indicates that tan δ is smaller, that is, a tire excellent in low heat build-up can be obtained.

TABLE 1

| Comparative | Comparative | Comparative | Comparative | Comparative | Comparative | Comparative | Example |
|---|---|---|---|---|---|---|---|
| Example 1 | Example 2 | Example 3 | Example 4 | Example 5 | Example 6 | Example 7 | 1 |

(Formulation)

| | | | | | | | | |
|---|---|---|---|---|---|---|---|---|
| SBR(1) | 100 | 100 | | | | | | |
| SBR(2) | | | 100 | 100 | | | | |
| SBR(3) | | | | | 100 | 100 | | |
| SBR(4) | | | | | | | 100 | 100 |
| Silica | 50 | 50 | 50 | 50 | 50 | 50 | 50 | 50 |
| Zinc oxide | 2 | 2 | 2 | 2 | 2 | 2 | 2 | 2 |
| Stearic acid | 2 | 2 | 2 | 2 | 2 | 2 | 2 | 2 |
| Silane coupling agent | 4 | | 4 | | 4 | | 4 | |
| Organic silane (1) | | | | | | | | |
| Organic silane (2) | | | | | | | | |
| Organic silane (3) | | 4 | | 4 | | 4 | | 4 |
| Sulfur | 2 | 2 | 2 | 2 | 2 | 2 | 2 | 2 |
| Vulcanization | 1.5 | 1.5 | 1.5 | 1.5 | 1.5 | 1.5 | 1.5 | 1.5 |
| accelerator (1) | | | | | | | | |
| Vulcanization | 1.5 | 1.5 | 1.5 | 1.5 | 1.5 | 1.5 | 1.5 | 1.5 |
| accelerator (2) | | | | | | | | |

(Evaluations)

| | | | | | | | | |
|---|---|---|---|---|---|---|---|---|
| Ei/Em | 3.1 | 1.7 | 1.5 | 1.7 | 1.6 | 1.7 | 1.6 | 1 |
| Wet grip performance | 100 | 105 | 100 | 99 | 100 | 105 | 100 | 116 |
| Low heat build-up | 100 | 104 | 100 | 118 | 100 | 119 | 100 | 84 |

Comparison between Comparative Example 2 and Comparative Example 1, comparison between Comparative Example 4 and Comparative Example 3, and comparison between Comparative Example 6 and Comparative Example 5 in Table 1 confirmed that none of Comparative Example 2, Comparative Example 4, and Comparative Example 6 containing, instead of the silane coupling agent, the organic silane having a terpene skeleton with a molecular weight of 200 to 1000 satisfied Ei/Em<1.5, and therefore some of the vulcanized rubbers had improved in WET performance but all the vulcanized rubbers had deteriorated in low heat build-up. On the other hand, as can be seen from the result of comparison between Example 1 and Comparative Example 7 in Table 1, Example 1 containing, instead of the silane coupling agent, the organic silane (3) having a terpene skeleton with a molecular weight of 200 to 1000 satisfies Ei/Em<1.5 (Ei/Em=1.0), and therefore the vulcanized rubber has significantly improved in both WET performance and low heat build-up.

TABLE 2

| | | |
|---|---|---|
| Comparative | | |
| Example 8 | Example 2 | Example 3 |

(Formulation)

| | | | |
|---|---|---|---|
| SBR(1) | | | |
| SBR(2) | | | |
| SBR(3) | | | |
| SBR(4) | 100 | 100 | 100 |
| Silica | 50 | 50 | 50 |
| Zinc oxide | 2 | 2 | 2 |
| Stearic acid | 2 | 2 | 2 |
| Silane coupling agent | 4 | | |
| Organic silane (1) | | 4 | |
| Organic silane (2) | | | 4 |
| Organic silane (3) | | | |
| Sulfur | 2 | 2 | 2 |
| Vulcanization accelerator (1) | 1.5 | 1.5 | 1.5 |
| Vulcanization accelerator (2) | 1.5 | 1.5 | 1.5 |

(Evaluations)

| | | | |
|---|---|---|---|
| Ei/Em | 1.6 | 1.4 | 1.1 |
| Wet grip performance | 100 | 107 | 112 |
| Low heat build-up | 100 | 89 | 87 |

As can be seen from the result of comparison between Examples 2 and 3 and Comparative Example 8 in Table 2, Example 2 containing, instead of the silane coupling agent, the organic silane (1) having a terpene skeleton with a molecular weight of 200 to 1000 and Example 3 containing, instead of the silane coupling agent, the organic silane (2) having a terpene skeleton with a molecular weight of 200 to 1000 satisfy Ei/Em<1.5 (Example 2: Ei/Em=1.4, Example 3: Ei/Em=1.1), and therefore these vulcanized rubbers have significantly improved in both WET performance and low heat build-up.

What is claimed is:

1. A rubber composition containing a diene-based rubber, silica, and an organic silane,
wherein when an elastic modulus of a rubber at an interface between the silica and the diene-based rubber is defined as Ei and an elastic modulus of a matrix rubber is defined as Em, Ei/Em<1.5.

2. The rubber composition according to claim 1, wherein the diene-based rubber is a modified styrene butadiene rubber.

3. The rubber composition according to claim 1, wherein the organic silane is a compound having a terpene skeleton with a molecular weight of 200 to 1000.

4. The rubber composition according to claim 1, wherein the organic silane is a compound represented by the following general formula (1): 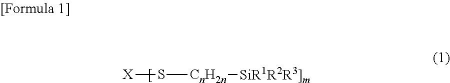
(wherein R¹, R², and R³ are each independently an alkyl group having 1 to 3 carbon atoms or an alkoxy group having 1 to 3 carbon atoms, at least one of R¹, R², and R³ is an alkoxy group, n is an integer of 2 to 4, X is a group having a terpene skeleton with a molecular weight of 200 to 1000, an intramolecular carbon-carbon double bond that X has is saturated or unsaturated, and X optionally contains a hetero element).

5. The rubber composition according to claim 1, wherein the organic silane is a product of an ene-thiol reaction between a compound represented by the following general formula (2):
[Formula 2]
HS—CₙH₂ₙ—SiR¹R²R³ (2)
(wherein R¹, R², R³, and n are the same as those in the above formula (1)) and at least one compound selected from the group consisting of a compound represented by the following general formula (3a): 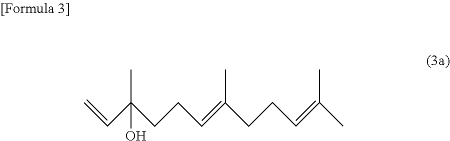
a compound represented by the following general formula (3b): 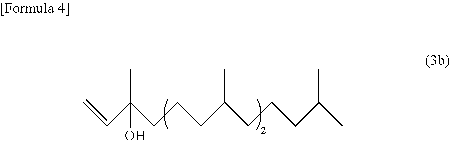
and a compound represented by the following general formula (3c):

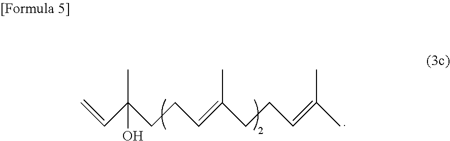

6. The rubber composition according to claim 1, wherein the silica is contained in an amount of 30 to 150 parts by mass when an entire amount of the diene-based rubber is taken as 100 parts by mass, and the organic silane is contained in an amount of 3 to 30 mass % of the amount of the silica.

7. A pneumatic tire comprising at least a vulcanized rubber of the rubber composition according to claim 1.
